(19) United States
(12) Patent Application Publication
(10) Pub. No.: US 2011/0026702 A1
(43) Pub. Date: Feb. 3, 2011

(54) MANAGING COMMUNICATIONS

(76) Inventor: Johannes Jan Bot, Nieuwendijk (NL)

Correspondence Address: ERICSSON INC., 6300 LEGACY DRIVE, M/S EVR 1-C-11, PLANO, TX, 75024, US

(21) Appl. No.: 12/936,281

(22) PCT Filed: Apr. 4, 2008
(86) PCT No.: PCT/EP2008/054116

§ 371 Date: Oct. 4, 2010

(51) Int. Cl. H04M 3/42

(52) U.S. Cl. 379/210.02

(57) ABSTRACT

A method of handling a request to set up a call between a calling party and a called party in a communication network. A switching node that serves the called party receives a request to set up a call from the calling party, and the request includes information identifying the calling party. The switching node invokes a call handling service for a comparison between the information identifying the calling party with identities of calling parties in a remote database, the identities having been provisioned by a third party. This allows a third party to provision information in the database that can be used for all subscribers to the call handling service. On the basis of the comparison, a decision is made on whether to set up the call or whether to invoke alternative call handling procedures such as barring calling party identity with identities in the call or diverting the call to, for example, a voice mailbox.

### TECHNICAL FIELD

The invention relates to the field of managing communications, and in particular to managing unwanted calls in a communications network.

### BACKGROUND

In a communications network, a calling party can call a receiving party and connect to the receiving party to set up a session. In some circumstances, the receiving party can block the call before the session is set up. This may be done, for example, by using a personal black/white list service in which the receiving party's terminal (such as a telephone) can decide whether or not to set up an incoming call by comparing the identity of the calling party with a list of barred identities stored in a database. For example, if a receiving party receives a malicious call, they can call a service number and order that the last calling party number, or identity, is stored in the database. Alternatively, the database can be populated in advance if the number of the malicious calling party is known.

EP1775922 discloses an example of a system for barring incoming calls in which the receiving terminal compares the number of the calling party with the contents of a database stored at the receiving terminal. If the calling party number matches a number in the database, then the receiving terminal can choose to bar the call.

Telephone users can receive unsolicited telephone advertisements and sales calls from telemarketers, and many users find this to be a nuisance. However, a problem arises because in order for the known methods of blocking telephone calls to be effective, the telephone number of a telemarketer must be known in advance. This is rarely the case, as telemarketers do not often repeat calls to the same user, or can call using different numbers, and so their number is unlikely to be on a database of numbers to bar.

One system to address this problem is to provide a voluntary code that telemarketers adhere to. A user who does not wish to receive telemarketing calls subscribes to a database, and if their number is on the database then the telemarketer will not call them. However, this requires self-policing by the telemarketers, and there is no guarantee that being registered with the database will prevent unscrupulous telemarketers from calling the user. A problem with existing systems is that there are no reliable mechanisms for preventing telemarketers from calling users who do not wish to receive calls

### SUMMARY

The invention provides a remote, centrally maintained database, which includes a list of barred numbers provisioned by a third party. This database is accessible by a user of a receiving terminal. On receiving an incoming call, a Service Control Function serving the receiving terminal checks the database and a comparison is made between the calling party number and the list of barred numbers. If a match is found then appropriate action is taken, which may include barring the call or routing it to another destination.

According to a first aspect of the invention, there is provided method of handling a request to set up a call between a calling party and a called party in a communication network. A Service Control Function node that serves the called party receives a request to set up a call, and the request includes information identifying the calling party. A comparison is made between the information identifying the calling party with identities of calling parties retrieved from a remote database, the identities having been provisioned by a third party. This allows a third party to provision information in the database that can be used for all subscribers to the call handling service. If the information identifying the calling party does not match with information retrieved from the remote database, then the call is set up between the called party and the calling party. On the other hand, if the information identifying the calling party matches information retrieved from the remote database, then further action is taken determined by call handling policies. The further action may optionally be either barring the call or diverting the call to, for example, a voice mailbox.

As an option, the remote database further comprises identities of calling parties associated with the called party. This allows the calling party to provision the database with calling party identities specific to that called party, and therefore introduces a degree of personalization in the call handling.

The Service Control Function node is optionally a switching node such as a Mobile Switching Centre and a Service Switching Point.

In some instances the called party will receive an unwanted call from a calling party who is not provisioned in the remote, centrally maintained database. The called party may wish to provision the calling party in the database, and so as an option the method further comprises, in the event that the call has been set up, receiving from the called party a request to provision the calling party identity in the database, and as a result of the request, provisioning the called party identity in the database. In order to prevent called parties from maliciously provisioning calling parties in the database, the calling party identity is optionally provisioned in the database after a predetermined number of different called parties have requested the calling party identity to be provisioned the database. Optionally, any person may check the database to see if they are incorrectly provisioned in the database and may apply to the operator of the database to have their entry in the database removed.

The method optionally further comprises receiving subscriber specific information from the database relating to the calling party identity, and determining whether to set up the call or take further action determined by call handling policies as a result of the subscriber specific information. An example of such information is allowing calls from a particular called party between certain hours.

According to a second aspect of the invention, there is provided a Service Control Function node for use in a communications network. The Service Control Function node is provided with a receiver for receiving a request to set up a call from a calling party, the request including information identifying the calling party. A processor is provided which compares information identifying the calling party with identities of calling parties retrieved from a remote database and provisioned in the database by a third party. On the basis of the comparison, a determination is made on whether to allow the call to be set up or whether to invoke different call handling procedures.

According to a third aspect of the invention, there is provided a database node for use in a communications network. The database node comprises a memory for storing identities of calling parties, the identities having been provisioned by a third party. A receiver is provided that can receive from a requesting node a request to interrogate the database. The request must include information identifying a calling party. A processor at the database node compares the information identifying the calling party in the request with the identities in the memory. A transmitter then sends the result of the comparison to the requesting node, which the requesting node can use to determine further call handling procedures, such as call diversion, call barring, or setting up the call.

In addition to the portion of the memory reserved for identities provision by a third party, the database node optionally further comprises a memory for storing at least one identity of a calling party specific to a single called party. This allows a subscriber to the service to have a personal “black list” of calling parties that will not apply to all subscribers of the service.

As an option, the receiver is arranged to receive a request sent from a called party to provision the memory with an identity of a new calling party. The processor handles this request and provisions the identity of the new calling party in the memory. Optionally, the identity of the calling party is only provisioned in the memory of the database node after a predetermined number of different called parties have requested the calling party identity to be provisioned the database, to prevent malicious called parties from unfairly provisioning the calling party identity in the database.

The receiver is optionally arranged to receive a request sent from a called party to provision the memory with an identity of a new called party, and the processor is arranged to, as a result of the request, provision the identity of the new called party in the memory such that it is associated with the called party. In this way, a called party can provision a calling party identity such that it only applies to the called party.

The request optionally further comprises a time stamp, and the processor is arranged to remove the request after the expiry of a predetermined time limit.

### BRIEF DESCRIPTION OF THE DRAWINGS

FIG. 1 illustrates schematically in a block diagram a network architecture;

FIG. 2 illustrates schematically in a block diagram a network architecture according to an embodiment of the invention;

FIG. 3 is a flow diagram showing the steps according to an embodiment of the invention;

FIG. 4 illustrates schematically in a block diagram a switching node according to an embodiment of the invention; and

FIG. 5 illustrates schematically in a block diagram a database checking function according to an embodiment of the invention.

### DETAILED DESCRIPTION

The following description refers to a number of the called party, although it will be appreciated that any identity of the called party can be used to populate and check a database.

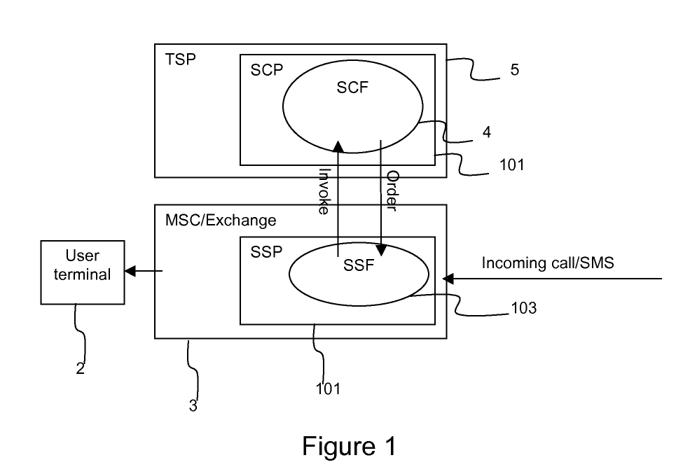

In order to better describe the invention, the system architecture for a called party is described with reference to FIG. 1. A Telephony Service Processor (TSP) node 5 is a general purpose processing platform that includes a Service Control Point (SCP) 101. The SCP 101 includes a Service Control Function (SCF) 4. The called party's user terminal 2 is served by a terminating Mobile Switching Centre (MSC) 3 that is provided with a Service Switching Point (SSP) 102. The SSP 102 has a Service Switching Function (SSF) 103. When an incoming call for the called party is detected in the MSC 3, the SSF 103 invokes a service to which the called party is subscribed. The service is handled in the SCP 101.

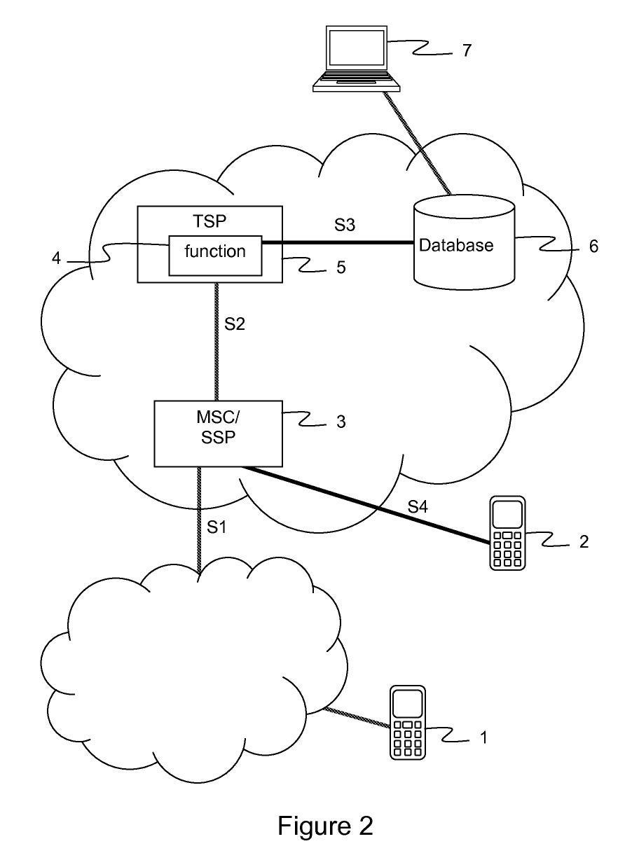

Referring to FIG. 2, a calling party 1 wishes to establish a call to a called party 2 via a communications network. The called party 2 has a subscription to a service in which the called party's number is checked against a database. The called party's 2 switching centre 3 invokes a database checking function on the basis of the called party's 2 subscription. A database checking function in the form of a Service Control Function 4 is provided in any suitable network node, and may be part of a TSP 5. The database checking function 4 refers to a centrally maintained database 6 and checks the number of the calling party 1 with the numbers stored in the database 6. If the calling party's 1 number is stored in the database 6, then further action can be taken, for example barring the call before the call is set up, or diverting the call, for example to a “junk” voicemail box that the called party 2 can access later, if required. An announcement may be played to the calling party 1 to inform them that the call is not being set up. On the other hand, if the calling party's 1 number is not stored in the database, then the call will be set up with the called party 2 as usual.

An incoming call for a user may invoke an incoming call handling service described above using standard service invocation methods, such as Terminating IN Category Key, or Terminating CAMEL Subscription Information, or alternative means as number range or number recognition methods. Of course, the user may also invoke the call handling service using fixed access communications, such as a telephone connected by a landline. In this case, the user can signal a request for adding a malicious calling number to the call handling service using Dual-tone multi-frequency (DTMF) signalling.

The database 6 may be provisioned in several ways. Initially, the database is provisioned with numbers provided by third parties such as Government bodies, police bodies, or telemarketers themselves. These numbers belong to telemarketers or malicious callers. If the owners of any of the numbers on the database attempt to call a person who subscribes to the service, the called person's service does not set up the call, but either bars it or handles it in a different way.

In some cases, a called party can receive a malicious call from a number that is not on the database 6. This may occur if the malicious caller is calling from a different number, or if the malicious caller is not known to the database. It would be advantageous for the called party to be able to add the malicious caller's number to the database. In this case, the called party 2 forwards the calling party's 1 number to the database 6 and the number is added to the database 6. There are several ways in which the called party 2 can forward the calling party's 1 number to the database 6. The called party's 2 number may be included in a string in an Unstructured Supplementary Service Data (USSD) that is triggered by the called party 2 and sent to the database checking function 4 or another suitable node. When the checking function 4 receives the USSD message requesting the calling party's 1 number to be included on the database, it generates a request to the database 6 to provision the calling party's 1 number. For fixed access telephones, the called party 2 can signal the service to provision the calling party's 1 number in the database using DTMF signalling.

The above request can be sent during or directly after the call. The user is not required to enter the calling party number as this is still known by the checking function as the current or last calling party identity. This is advantageous as malicious calling parties often use Calling Line Identity suppression which inhibits the display of the calling party number on the called party terminal.

Another method for the request is to send a Short Message Service (SMS) message to database checking function 4. According to this embodiment, the called party is not required to enter the calling party number as it is known by the checking function.

The checking function allows only one request for a call in progress or made. It therefore flags the calling party number after the first request so no further request can be made.

Yet another method to provision the database 6 is for the called party 2 to send a Short Message Service (SMS) message directly to the database 6, the SMS message containing the calling party's number and a request to enter their number in the database 6. A disadvantage with using SMS sent directly to the database is that a called party 2 could resend the same message many times in order to have a calling party's 1 number provisioned in the database 6 without reason or even without having called. Note that a request to provision a called party's 1 number in the database may have a limited duration in which it is valid, to ensure that requests do not remain in the system indefinitely.

Of course, a malicious called party 2 may wish to have the calling party's 1 number added to the database without reason. To address this possible abuse of the database, the database may be configured so as to only add a calling party's 1 number to the database 6 once it has received, for example, five requests for the calling party's 1 number to be added, or a lower number of requests, for example three but from three different called parties.

In one embodiment, the database is arranged to allow only one present request for provisioning a calling party's number per called party identity. The database therefore maintains a list of requests in which no double entries may exist. Any further requests for the provisioning of a certain calling party number by the same called party will be denied.

With each new entry, the database determines if the list contains further entries for the same calling party. When the number of entries found exceeds the predetermined number, the calling party number is added to the list of calling party numbers valid for all users for the service. All requests in the list having the same calling party number are then removed from the list.

In one embodiment of the invention, the database adds the calling party number directly to a personal list of the called party upon receiving a single request.

Anyone may access the database to ascertain whether their number has been incorrectly placed on the database 6, and may apply to the database 6 operator to have their number removed if it can be shown that their number should not be provisioned on the database 6. Access may be via a web-based Graphical User Interface (GUI) 7 such as an Internet browser.

The web-based GUI 7 can also be used to provision the database 6 with a malicious calling party number as an alternative to USDD, DTMF or SMS to request provision.

In one embodiment of the invention, in order to monitor operation of the database 6 and the service, a report is generated each time the service is invoked, which should at least contain the calling party number, the called party number, the data and the time.

In addition to the data stored in the database that can be applied to incoming calls to all subscribers of the service, the database may also include information relevant to each subscriber. The database therefore contains a ‘global’ list of calling party numbers provisioned by a third party that are checked for incoming calls to all subscribers of the service, and also a ‘subscriber’ list of calling party numbers that the subscriber can provision and maintain. In this way, the subscriber may, for example, have the service bar calls from a work number to the user's private number. This barring can be conditional, for example the service will allow the setup of a call from a work number to the user as long as the call is between the hours of 8 am and 10 pm.

The ‘subscriber’ list of numbers is only checked against incoming calls for that particular subscriber. The subscriber can manage their ‘subscriber’ list of numbers either using their mobile equipment or using the web-based GUI 7.

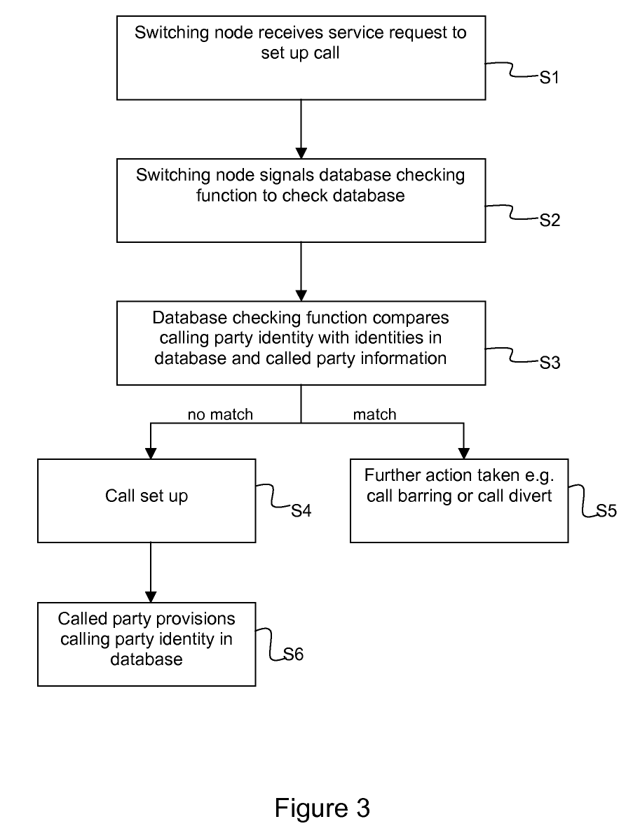

In order to summarize the steps of an embodiment of the invention, FIG. 3 is a flow diagram. The following numbering corresponds to the numbering in FIG. 3.

S1. The switching node 3 receives a service request to set up a call between the calling party 1 and the called party 2.

S2. The switching node 3 communicates with the database checking function 4 to check the database 6.

S3. The database checking function 4 compares the calling party identity with identities in the database 6. These identities may be global and/or specific to the called party 2.

S4. If the calling party identity does not match relevant entries in the database, then the call is set up.

S5. If the calling party identity does match a relevant entry in the database, then further action is taken, such as call barring or call diversion.

S6. If the call has been set up and the called party 2 wishes to provision the calling party's 1 identity in the database, then the called party 2 forwards the calling party's identity to the database 6 for provisioning.

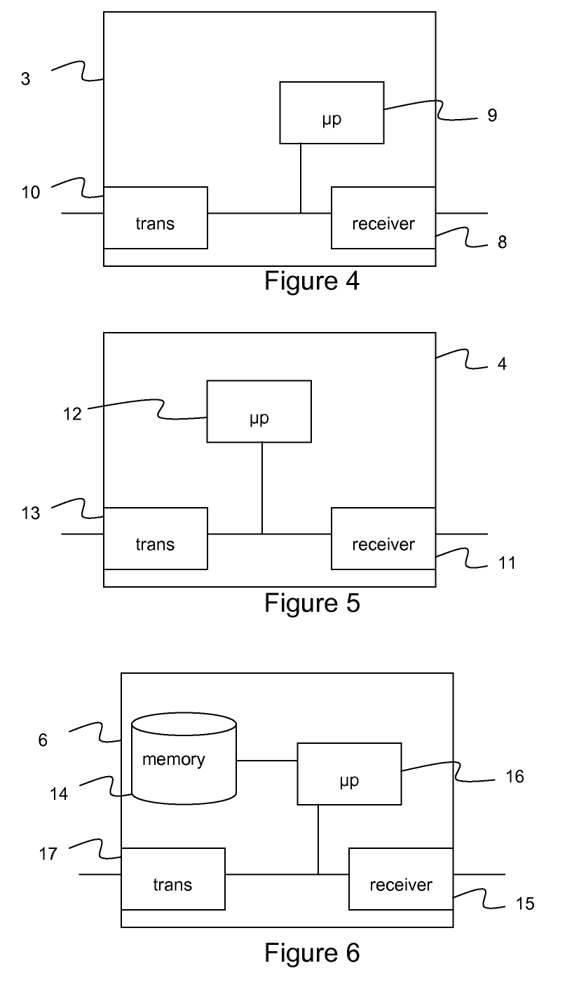

Referring now to FIG. 4, there is illustrated a switching node such as a MSC or SSP according to an embodiment of the invention. The switching node 3 is provided with a receiver 8 for receiving a request to set up a call from the calling party 1. A processor 9 is also provided for determining whether or not to set up the call on the basis of a comparison of the calling party's 1 identity with identities retrieved from a remote database 7. In one embodiment, the switching node 3 also includes a transmitter 10 for sending a message to the remote database checking function 4. The message includes information identifying the called party and the calling party, and a request for the database checking function to make the comparison of information identifying the calling party with identities of calling parties retrieved from a remote database.

FIG. 5 illustrates a database checking function 4 according to an embodiment of the invention. The database checking function 4 is provided with a receiver 11 for receiving a message containing information identifying a called party and a calling party from the switching node 3. A processor 12 is provided for comparing the information identifying the calling party with identities of calling parties retrieved from the remote database 6, and a transmitter 13 is also provided for sending the results of the comparison to the switching node. The database checking function 4 may be disposed in any suitable node, for example a TPS.

FIG. 6 illustrates a database node 6 according to an embodiment of the invention. In this case, the database node 6 performs the check of the calling party against identities stored in the database. The database node 6 comprises a memory 14 for storing identities of calling parties. The identities are provisioned by a third party and are applied to all subscribers to the service, and the memory 14 may also include identities of calling parties specific to each subscriber, so that subscribers can maintain their own personal “black list”. A receiver 15 is arranged to receive a request from a remote node to interrogate the database. A processor 16 processes the request and compared the identity of the calling party contained in the request with the identities stored in the memory 14. The results of the comparison (either a match is found or not, and may also include call handling policies) is sent using a transmitter 17 to the remote node.

The invention provides a mechanism that allows screening of unwanted calls to a user. Call numbers to be screened may apply to all users subscribing to the service, or may be specific to each subscriber. It will be apparent to a person skilled in the art that the invention can also apply to short messages services (SMS) in addition to or instead of voice calls, although in this case the SMS message is either diverted or discarded. It will be appreciated by a person of skill in the art that various modifications may be made to the above described embodiments without departing from the scope of the present invention.

1. A method of handling a request to set up a call between a calling party and a called party in a communication network, the method comprising
at a switching node serving the called party, receiving a request to set up a call from the calling party, the request including information identifying the calling party;
as a result of receiving the request, invoking a database checking function for comparing the information identifying the calling party with identities in a remote database, the identities having been provisioned by a third party;
in the event that the information identifying the calling party does not match identities in the remote database, setting up the call, and in the event that the information identifying the calling party matches with an identity in the remote database, taking further action determined by call handling policies.

2. The method according to claim 1, wherein the remote database further comprises identities associated with a single called party.

3. The method according to claim 1 or 2, wherein the switching node is any one of a Mobile Switching Centre, telephone exchange, and a node performing a telephony switching function, and the switching node is equipped with a Service Switching Point.

4. The method according to claims 1 to 3, wherein the remote database checking function is a Service Control Function.

5. The method according to any one of claims 1 to 4, wherein the further action is selected from one of barring the call and diverting the call.

6. The method according to any one of claims 1 to 5, further comprising, in the event that the call has been set up:
receiving from the called party a request to provision the calling party identity in the database, and
as a result of the request, provisioning the called party identity in the database.

7. The method according to claim 6, wherein the calling party identity is provisioned in the database after a predetermined number of different called parties have requested the calling party identity to be provisioned the database.

8. The method according to any one of claims 1 to 7, further comprising:
receiving subscriber specific information from the database relating to the calling party identity, and determining whether to set up the call or take further action determined by call handling policies as a result of the subscriber specific information.

9. A switching node for use in a communications network, the switching node comprising:
a receiver for receiving a request to set up a call from the calling party, the request including information identifying the calling party;
a transmitter for, as a result of receiving the request, invoking a database checking function for comparing the information identifying the calling party with identities in a remote database, the identities having been provisioned by a third party;
a processor for, in the event that the information identifying the calling party does not match with identities in the remote database, setting up the call, and in the event that the information identifying the calling party matches with identities in the remote database, taking further action determined by call handling policies.

10. A Service Control Function node for use in a communications network, the Service Control Function node comprising:
a receiver for receiving a request to check a remote database, the request including information identifying a calling party;
a processor for determining, on the basis of a comparison of information identifying the calling party with identities of calling parties in a remote database and provisioned in the database by a third party, whether to allow the call to be set up with the called party or take further action determined by call handling policies.

11. A database node for use in a communications network, the database node comprising:
a memory for storing identities of calling parties, the identities having been provisioned by a third party;
a receiver for receiving from a requesting node a request to interrogate the database, the request including information identifying a calling party;
a processor for comparing the information identifying a calling party in the request with the identities in the memory; and
a transmitter for sending the results of the comparison to the requesting node for use by the requesting node to determine further call handling procedures.

12. The database node according to claim 11, further comprising a memory for storing at least one identity of calling parties specific to a single called party.

13. The database node according to claim 11 or 12, wherein the receiver is arranged to receive a request sent from a called party to provision the memory with an identity of a new calling party, and the processor is arranged to, as a result of the request, provision the identity of the new calling party in the memory.

14. The database node according to claim 13, wherein the processor is arranged to provision the memory with the identity of the new calling party after a predetermined number of different called parties have requested the calling party identity to be provisioned the database.

15. The database node according to claim 12, wherein the receiver is arranged to receive a request sent from a called party to provision the memory with an identity of a new called party, and the processor is arranged to, as a result of the request, provision the identity of the new called party in the memory such that it is associated with the called party.

16. The database node according to any one of claims 11 to 15, wherein the request further comprises a time stamp, and the processor is arranged to remove the request after the expiry of a predetermined time limit.
